(19) United States
(12) Patent Application Publication
(10) Pub. No.: US 2024/0160924 A1
(43) Pub. Date: May 16, 2024

(54) AUTOMATED SURROGATE TRAINING PERFORMANCE BY INCORPORATING SIMULATOR INFORMATION

(71) Applicant: JuliaHub, Inc., Boston, MA (US)

(72) Inventors: Christopher Rackauckas, Cambridge, MA (US); Anas Abdelrehim, Toronto (CA); Ranjan Anantharaman, Newton, MA (US)

(21) Appl. No.: 18/424,281

(22) Filed: Jan. 26, 2024

Related U.S. Application Data
(63) Continuation of application No. PCT/US22/74231, filed on Jul. 28, 2022.
(60) Provisional application No. 63/226,641, filed on Jul. 28, 2021.

(51) Int. Cl. G06N 3/08

(52) U.S. Cl. CPC G06N 3/08

(57) ABSTRACT

Methods and computer systems for improving automated surrogate training performance on specific applications by incorporating simulator information into the learnable architecture are disclosed. They allow for a chosen architecture to more closely resemble the system being modeled, which allows the chosen architecture to do so more efficiently, in terms of computational efficiency as well as amount of training data required, and more accurately. A prior analysis of the system being modeled is performed, either before the training phase or during the training phase as modifications to the loss function, to determine one or more mathematical properties that have clear ways of being baked into the architecture, for example by scaling a reservoir of the surrogate to the proper time scale for the system being modeled.

### CROSS-REFERENCE TO RELATED APPLICATIONS

This application is a continuation of PCT Patent Application No. PCT/US2022/074231, filed on Jul. 28, 2022, entitled “IMPROVING AUTOMATED SURROGATE TRAINING PERFORMANCE BY INCORPORATING SIMULATOR INFORMATION”, which claims priority to U.S. Provisional Patent Application No. 63/226,641 filed on Jul. 28, 2021, entitled, “AUTOMATED SURROGATE TRAINING PERFORMANCE BY INCORPORATING SIMULATOR INFORMATION,” the entire contents of all of which are incorporated by reference herein.

### GOVERNMENT SUPPORT

This invention was made with Government support under Agreement No. HR00112190048, awarded by DARPA. The Government has certain rights in the invention.

### TECHNICAL FIELD

The field of the invention relates generally to methods and systems for improving scientific computing. More specifically, the field of the invention relates to methods and systems for improving automated surrogate training performance on specific applications by incorporating simulator information into the learnable architecture.

### BACKGROUND

Surrogates are machine-learned approximations of an original model that are used to accelerate simulation of the original model. Many surrogate techniques use black-box machine-learning architectures, such as neural networks or continuous-time echo state networks (CTESNs), which effectively learn to mimic the behavior of the model from data over a given operating parameter space. However, the surrogates generated by black-box machine-learning architectures are not necessarily the most accurate or the most efficient approximations of the original model.

Accordingly, there is a need for a methods and systems that generate more accurate and/or more efficient surrogates for an original model.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Disclosed herein are methods and computer systems that improve automated surrogate training performance on specific applications by incorporating simulator information into the learnable architecture. They allow for a chosen architecture to more closely resemble the system being modeled, which allows the chosen architecture to do so more accurately and more efficiently in terms of computational efficiency as well as amount of training data required. As explained in more detail below, a prior analysis of the system being modeled is performed, either before the training phase or during the training phase as modifications to the loss function, to determine one or more mathematical properties that have clear ways of being baked into the architecture, for example by scaling a reservoir of the surrogate to the proper time scale for the system being modeled.

In one embodiment of the methods and systems for improving automated surrogate training performance on specific applications by incorporating simulator information into the learnable architecture, a computer system for improving automated surrogate training performance by incorporating simulator information is disclosed. The computer system includes a memory and a processor. The processor is configured for performing a simulation of a system being modeled. The processor is further configured for identifying, based on the simulation of the system being modeled, information about the system being modeled. The processor is further configured for modifying an architecture of a surrogate of the system being modeled. The architecture of the surrogate is modified to incorporate the identified information about the system being modeled. The processor is further configured for training the surrogate with the information about the system being modeled to generate a final surrogate.

In another embodiment of the methods and systems for improving automated surrogate training performance on specific applications by incorporating simulator information into the learnable architecture, a method for improving automated surrogate training performance by incorporating simulator information is disclosed. The method includes performing a simulation of a system being modeled. The method further includes identifying, based on the simulation of the system being modeled, information about the system being modeled. The method further includes modifying an architecture of a surrogate of the system being modeled. The architecture of the surrogate is modified to incorporate the identified information about the system being modeled. The method further includes training the surrogate with the information about the system being modeled to generate a final surrogate.

In another embodiment of the methods and systems for improving automated surrogate training performance on specific applications by incorporating simulator information into the learnable architecture, a system for improving automated surrogate training performance by incorporating simulator information is disclosed. The system includes a memory and a processor. The processor is configured for creating a model of a system being modeled. The processor is further configured for defining a surrogate having a surrogate architecture for the model of the system being modeled. The surrogate architecture is a CTESN, a neural network, a PINN, or a neural ODE. The processor is further configured for performing one or more simulations of the model to identify information about the system being modeled. The processor is further configured for identifying, based on the one or more simulations of the model, information about the system being modeled. The identified information about the system includes average Jacobian norms, Jacobian eigenvalues, maximum or minimum values of states of the model over time, mean values of states of the model over time, length of time to run the simulation, maximum of a time series of the model, natural bounds of the model, or periodicity of the model. The processor is further configured for generating an improved surrogate by modifying the surrogate architecture using the identified information about the system being modeled from the one or more simulations. The processor is further configured for generating a final surrogate by training the improved surrogate.

In another embodiment of the methods and systems for improving automated surrogate training performance on specific applications by incorporating simulator information into the learnable architecture, a method for improving automated surrogate training performance by incorporating simulator information is disclosed. The method includes creating a model of a system being modeled. The method further includes defining a surrogate having a surrogate architecture for the model of the system being modeled. The surrogate architecture is a CTESN, a neural network, a PINN, or a neural ODE. The method further includes performing one or more simulations of the model to identify information about the system being modeled. The method further includes identifying, based on the one or more simulations of the model, information about the system being modeled. The identified information about the system includes average Jacobian norms, Jacobian eigenvalues, maximum or minimum values of states of the model over time, mean values of states of the model over time, length of time to run the simulation, maximum of a time series of the model, natural bounds of the model, or periodicity of the model. The method further includes generating an improved surrogate by modifying the surrogate architecture using the identified information about the system being modeled from the one or more simulations. The method further includes generating a final surrogate by training the improved surrogate.

As can be seen below, the methods and systems described herein provide a practical application in that they generate significant improvements in both performance speed and performance accuracy in simulations of complex models being run as part of scientific computing. These improvements in performance and speed make modeling and scientific computing cheaper, more efficient, and more accurate. Additionally, the methods and systems described herein improve the functioning of a computer performing scientific computing by allowing the computer to more accurately and efficiently simulate a system being modeled. The methods and systems described herein may incorporated, for example, into a compiler to improve the operation of the compiler when creating and running simulations in scientific computing.

### BRIEF DESCRIPTION OF THE DRAWINGS

The present embodiments are illustrated by way of example and are not intended to be limited by the figures of the accompanying drawings.

FIG. 1 shows a process flow of an exemplary method of improving automated surrogate training performance on specific applications by incorporating simulator information into the learnable architecture according to an embodiment of the subject matter described herein.

FIG. 2 shows an exemplary comparison of a result generated by a traditional CTESN surrogate when approximating a system for controlling quantum computers, as compared to the known ground truth.

FIG. 3 is a chart showing the first 50 state trajectories for the unscaled dynamics of the reservoir used when generating the result shown in FIG. 2.

FIG. 4 is a chart showing the first 50 state trajectories for the scaled dynamics of the reservoir used when generating a result using an improved CTESN surrogate according to an embodiment of the subject matter described herein.

FIG. 5 shows an exemplary comparison of a result generated using an improved CTESN surrogate according to an embodiment of the subject matter described herein, as compared to the known ground truth.

FIG. 6 depicts the percentage error of the improved CTESN surrogate according to an embodiment of the subject matter described herein from the known ground truth as shown in FIG. 5.

FIG. 7 depicts a simulation time comparison between the original model and the improved CTESN surrogate according to an embodiment of the subject matter described herein as the fidelity of the input increases.

FIG. 8A displays training results of a traditional CTESN surrogate on a MOSFET system as compared to the known ground truth.

FIG. 8B displays the absolute error of the training results of a traditional CTESN surrogate on a MOSFET system as compared to the known ground truth shown in FIG. 8A.

FIG. 9 depicts a block diagram illustrating one embodiment of a computing device that implements the methods and systems for improving automated surrogate training performance on specific applications by incorporating simulator information into the learnable architecture described herein.

### DETAILED DESCRIPTION

The following description and figures are illustrative and are not to be construed as limiting. Numerous specific details are described to provide a thorough understanding of the disclosure. In certain instances, however, well-known or conventional details are not described in order to avoid obscuring the description. References to “one embodiment” or “an embodiment” in the present disclosure may be (but are not necessarily) references to the same embodiment, and such references mean at least one of the embodiments. The word “exemplary” is used herein to mean “serving as an example, instance, or illustration.” Any embodiment described herein as “exemplary” is not necessarily to be construed as preferred or advantageous over other embodiments.

The methods and systems for improving automated surrogate training performance described herein are described in the context of various embodiments. For example, in one embodiment described herein, the methods and systems are described in the context of improving a simulation of an exemplary system for controlling quantum computers. In another embodiment described herein, the methods and systems are described in the context of improving a simulation of the operation of a MOSFET system. In another embodiment described herein, the methods and systems are described in the context of an open-ended simulation. However, it will be understood that the principles described herein can be applied to improve the performance of a surrogate in modeling any type of complex system.

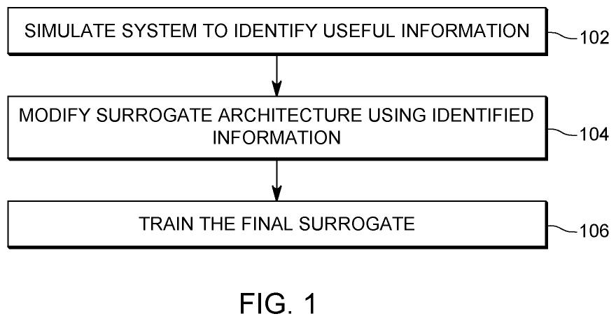

FIG. 1 shows a process flow of an exemplary method of improving automated surrogate training performance on specific applications by incorporating simulator information into the learnable architecture.

The methods described herein, including the exemplary method shown in FIG. 1, may be implemented on a computer system having a memory and circuitry configured to execute the method described herein. The circuitry can be any of the various commercially available processors, including without limitation processors made by AMD®, Intel®, or other similar processors. Dual microprocessors, multi-core processors, and other multi-processor architectures may also be employed as circuitry. According to some examples, the circuitry can also be an application specific integrated circuit (ASIC). According to other examples, the circuitry can be any of the various commercially available graphics processing units (GPUs) for high-performance processing of the models and/or simulations. According to other examples, the methods described herein may be implemented as a cloud-based platform for modeling and simulation. Such a cloud-based platform may include circuitry that executes code that implements the methods described herein, including one or more processors.

Referring to FIG. 1, at step 102, the circuitry performs one or more simulations of the system being modeled to identify potentially useful information about the system being modeled. The potentially useful information identified may be values that include, for example, average Jacobian norms, Jacobian eigenvalues, maximum and minimum values of certain states over time, mean over time, length of time to run the simulation, maximum of any time series along the whole simulation, whether the simulation is periodic, or the like. The one or more simulations may be run using multiple different values to allow the circuitry to learn relevant properties about the system being modeled. For example, the system being modeled may be such that its values are naturally bounded. Running one or more simulations of the system being modeled may be used to identify those natural bounds, for example. As an example, the system being modeled may be a bicycle. The one or more simulations may be performed to ascertain that the system (i.e., the bicycle) will never move at more than, say, 100 miles per hour.

At step 104, the circuitry may modify the surrogate architecture to incorporate the identified values into its definition. The surrogate architecture is a mathematical form of the surrogate, which is a function approximator that can accelerate the forward pass of a scientific simulation. The surrogate architecture may be, for example, a CTESN, a neural network, a PINN, a neural ODE, or the like. The surrogate with the modified architecture may be thought of as an improved surrogate.

At step 106, the circuitry trains the final surrogate as part of the architecture. The trained final surrogate will be the improved surrogate that has been trained.

Additionally, and optionally, the circuitry may continue to update the identified values and/or modify the surrogate architecture during the surrogate training process as more information is learned through the sampling process.

### Description of the Continuous-Time Echo State Network (CTESN)

In the CTESN, a random, non-stiff, ordinary differential equation (“ODE”) is constructed. This random, non-stiff ODE is referred to as the reservoir. The reservoir is constructed by exciting a fixed neural network neural layer with a chosen input, and its response is evolved over time. The dynamics are given by the following equation:

$$\frac{dr}{dt} = f ( A * r + {W}_{hyb} * x ( {p}^{*} , t ) )$$

In the above equation:

x(p*, t) is a solution at some time point in the chosen parameter space of the reference model with dimension N.

W_{hyb} is a N_{R}×N dense random matrix that couples the physics-informed excitation to the reservoir.

A is an N_{R}×N_{R} sparse random matrix representing the connections of the reservoir. The way A is chosen is dependent on the system being modeled or the problem being solved. A is a sparse random matrix representing the connections of the reservoir that is kept constant in the training process. Traditionally for a CTESN, A is generated by generating a matrix representing a random Erdos-Renyi graph consisting of ones and zeros. However, as described herein, A can be selected to create an improved CTESN that provides a more accurate simulation by first running the simulation as described above to gather information about the system and then selecting A based on the gathered information.

r is the current state of each of the reservoir nodes.

Projections are then calculated from the reservoir to an ensemble of reference solutions at various points in a chosen input parameter space P. They are generally defined as:

x(t)=g(projection(r(t)))

g is known as the projection activation function.

Therefore, at any parameter set, a projection is trained from a reservoir time series to a reference time series at that parameter set. This projection can be linear, in which case it can be trained using least squares fitting using the singular value decomposition (SVD):

x(t)=Wₒᵤₜ* r(t)

This projection can also be non-linear, in which case it is fit by computing by fitting the coefficients β of a radial basis function.

x(t)=rbf(β)(r(t))

These two variants are referred to as linear-projection CTESN (LPCTESN) and nonlinear-projection CTESN (NPCTESN), respectively.

### First Embodiment: Scaling Reservoir Dynamics of CTESNs Based on Simulation Timescales

In one embodiment, the methods and systems disclosed herein are described in the context of improving a simulation of a system for controlling quantum computers. A traditional CTESN surrogate can properly match the qualitative behavior of the baseline output waveform for this simulation. However, a traditional CTESN may fail to fully capture the oscillations of the circuit model. For example, this problem may be observed when a prediction is attempted on an input waveform outside the trained parameter region. While some accuracy degradation is to be expected, a disagreement to the degree observed indicates that the traditional CTESN surrogate was unable to resolve some important process in the underlying circuit model. This problem is addressed by the methods and systems described herein.

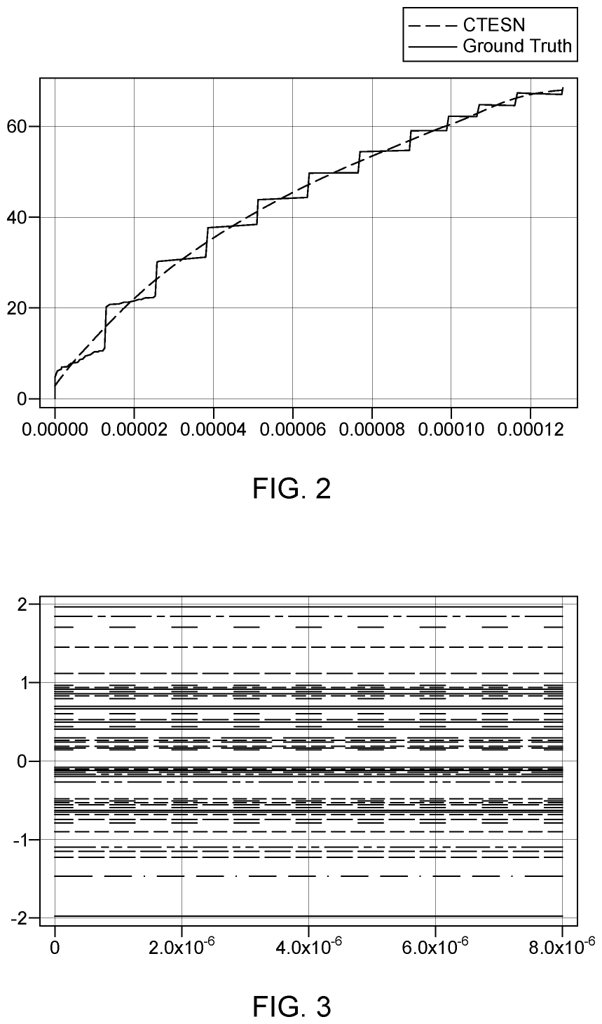

FIG. 2 shows an exemplary comparison of a result generated by a traditional CTESN surrogate when approximating a system for controlling quantum computers, as compared to the known ground truth.

As can be seen in FIG. 2, the ground truth of the system being modeled includes oscillating-like dynamics (as shown with the solid stair-stepped line in FIG. 2). The best fit that a traditional CTESN surrogate was able to provide was a smooth, curve-like approximation to the oscillating-like dynamics (as shown with the dashed line in FIG. 2). Such a rough, smooth approximation indicates that the activity of the reservoir for the traditional CTESN is not rich enough to fit the dynamics at hand. This lack of richness is because of the large time scale difference between the dynamics of the reservoir being used to create a surrogate of the model, and the dynamics of the model itself. In other words, the traditional CTESN surrogate does not provide accurate output when using a standard A matrix.

FIG. 3 is a chart showing the first 50 state trajectories for the unscaled dynamics of the reservoir used when generating the result shown in FIG. 2.

Referring to FIG. 3, the plotting of the first 50 of the 500 states of the reservoir dynamics in FIG. 3 clearly demonstrates the lack of richness because of the large time scale difference, where the dynamics of the reservoir seem almost linear. This means that the time-scale of the reservoir, which will be projected to mimic the original simulation, is longer than the actual simulation. In other words, in the time-scale of the original simulation, the reservoir has essentially no behavior because its rates of change are more suited for a longer simulation. This is because the model dynamics of system being modeled operate in such a small time span (0, 1e-6), that dynamics that are much slower than this look like a line at that time scale. This explains why only a smooth, curve-like approximation was possible as that is the best possible fit that can be arrived at given by the almost linear-like dynamics provided by the reservoir.

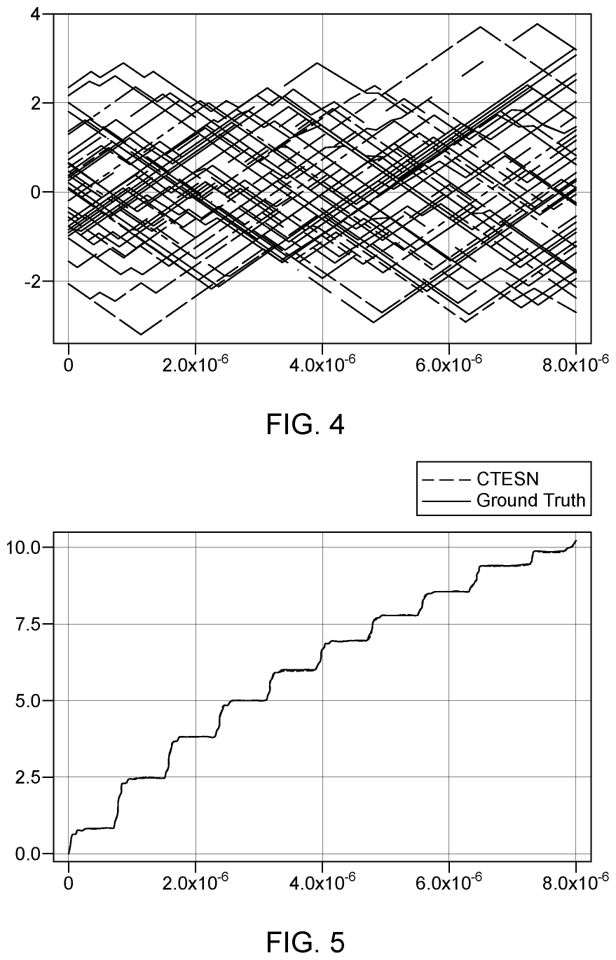

To solve this problem, the dynamics of the reservoir are scaled by a factor that represents the time scale associated with the model's dynamics. Implementing this change allows for the distributions of eigenvalues of the reservoir to be shifted to the correct scale, as illustrated in FIG. 4, giving the projection the rich dynamics it needs to properly fit the model. This may be performed automatically in the fitting process by running one or more simulations and calculating values such as Jacobian norms and eigenvalues to determine appropriate scaling constants to effectively re-scale the reservoir matrix A, or change the sampling process entirely.

FIG. 4 is a chart showing the first 50 state trajectories for the scaled dynamics of the reservoir used when generating a result using an improved CTESN surrogate according to an embodiment of the subject matter described herein.

As can be seen from FIG. 4, the scaled dynamics of the reservoir provides far better performance of an improved CTESN surrogate as described herein on test parameters for which a traditional CTESN surrogate had previously failed (as shown, for example, in FIG. 2).

FIG. 5 shows an exemplary result generated using a new CTESN surrogate according to an embodiment of the subject matter described herein, as compared to the known ground truth.

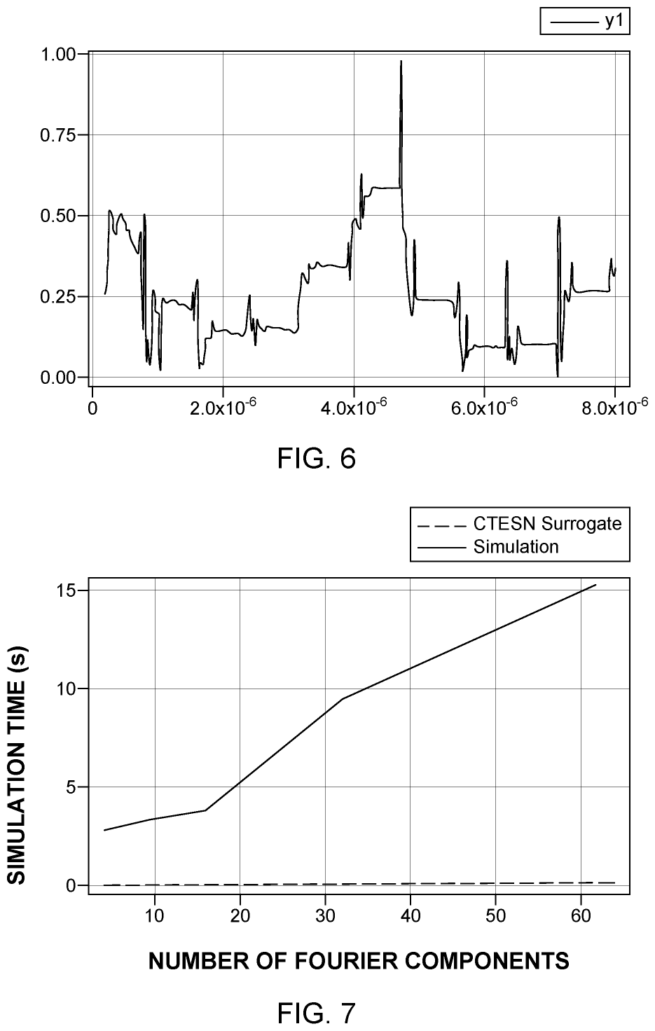

As can be seen from FIG. 5, the improved CTESN surrogate provides results that are quite similar to the ground truth (as shown by the overlapping dashed and non-dashed lines in FIG. 5). In fact, the performance of the improved CTESN surrogate is such that the percentage error is less than 1% throughout the test parameter trajectory for four Fourier components. This can be seen, for example, in FIG. 6.

FIG. 6 depicts the percentage error of the improved CTESN surrogate according to an embodiment of the subject matter described herein from the known ground truth as shown in FIG. 5.

Referring to FIG. 6, even as more Fourier components are added to increase the resolution of the driving signal to the circuit, the improved CTESN surrogate as described hercin maintained a sub-5% error and provided speed ups between 75 and 147 times as more components were added. This can be seen, for example, in FIG. 7.

FIG. 7 depicts a simulation time comparison between the original model and the improved CTESN surrogate according to an embodiment of the subject matter described herein as the fidelity of the input increases.

The results shown in FIGS. 4-7 demonstrate the benefits of the improved CTESN surrogates according to the methods and systems described herein, as well as the benefits of successfully accelerating the workflow for mixed signal circuits using this approach.

### Second Embodiment: Changing the Reservoir Sampling Process to Match Asymptotic Characteristics

In one embodiment described herein, the methods and systems are described in the context of improving a simulation of the operation of a MOSFET system. Because the goal is to project the reservoir to match the behavior of the original system (i.e., the MOSFET), the reservoir should match the qualitative characteristics of the system. Whereas in the quantum computing example described above, the A matrix was selected to adjust the time scale of the simulation, in the MOSFET example described now, the A matrix is selected to adjust the periodicity of the simulation.

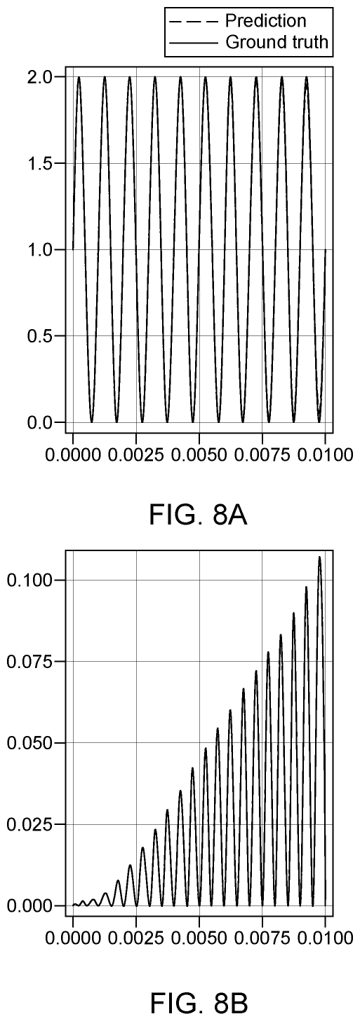

FIG. 8A displays training results of a traditional CTESN surrogate on a MOSFET system as compared to the known ground truth. A MOSFET is a periodic system while the chosen sampling process for the reservoir matrix A does not result in a periodic reservoir system.

FIG. 8B displays the absolute error of the training results of a traditional CTESN surrogate on a MOSFET system as compared to the known ground truth shown in FIG. 8A. As can be seen in FIG. 8A and 8B, the traditional CTESN surrogate prediction drifts over time since the surrogate is trying to mimic a periodic system with a non-periodic system. For example, FIG. 8B clearly shows that the absolute error grows over time. This drift over time can be improved by generating a reservoir matrix A that causes periodicity in the reservoir dynamics. This may be accomplished by sampling the reservoir A to ensure that it has complex cigenvalues, such as by directly generating a diagonal matrix D with the desired eigenvalues and then applying a random similarity transformation A=QDQ^{T}, where Q is given an orthogonal matrix generated via the QR-factorization of some random matrix. The eigenvalues for the starting point, D, may be determined by prior eigensystem analysis of simulations before conducting the training process, or they may be given as prior information by the user. The spread of eigenvalues, along with their relative complex and real part sizing, is important for this to fit well. The matrix D may be scaled to the relative size of the eigenvalues from the original system, which would be equivalent to the scaling discussed above in the context of the quantum computing example.

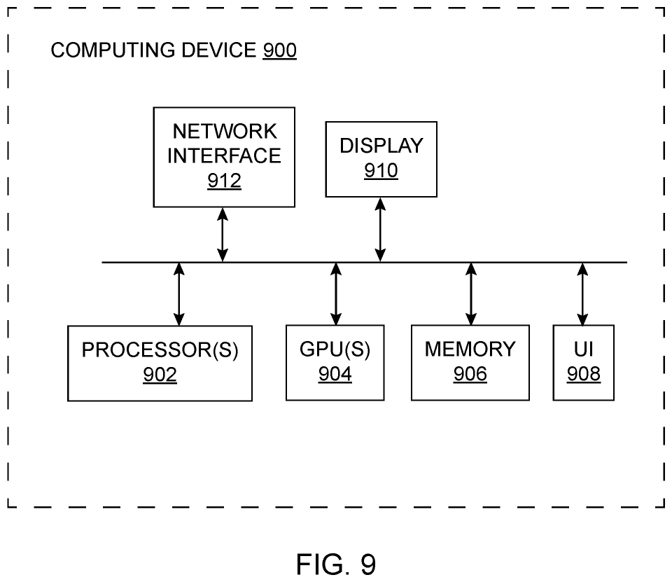

FIG. 9 depicts a block diagram illustrating one embodiment of a computing device that implements the methods and systems for improving automated surrogate training performance on specific applications by incorporating simulator information into the learnable architecture described herein. Referring to FIG. 9, the computing device 900 may include at least one processor 902, at least one graphical processing unit (“GPU”) 904, a memory 906, a user interface (“UI”) 908, a display 910, and a network interface 912. The memory 906 may be partially integrated with the processor(s) 902 and/or the GPU(s) 904. The UI 908 may include a keyboard and a mouse. The display 910 and the UI 908 may provide any of the GUIs in the embodiments of this disclosure.

### Third Embodiment: Specifying Physics-Informed Neural Network (PINN) Architectures via Prior Simulations

In another embodiment described herein, the methods and systems are described in the context of an open-ended simulation. Such an open-ended simulation may be performed using, for example, the CTESN described above as a surrogate, or it may be performed using a physics-informed neural network as a surrogate. Physics-informed neural networks (PINNs) are neural networks whose loss functions are specified such that, if the loss is zero, the neural network is the solution to a given system of differential equations. This training process can be done without requiring a simulator capable of generating simulation data from said system. However, if a simulator for the given partial differential equation system does exist, then properties of the system may be tabulated at various parameters. For example, the maximum and minimum of the solution over all sets of parameters may be calculated, and/or the average Jacobian. Instead of using a completely black box PINN architecture, the training process may incorporate these details automatically before doing the training. For example, by using a sigmoid activation function in the last layer of the neural network, the PINN surrogate will be constrained to have a solution within [0,1], and a scaling factor of s multiplied to the output will constrain the solution to [0, s]. Similarly, a scaled hyperbolic tangent activation function will constrain the solution to an interval [−s, s], where a bias term b may then shift the interval to [−s+b, s+b]. The appropriate values of s and b may be chosen from the simulations, with extra padding added on to account for the uncertainty of the potential values of the surrogate at new parameters. For example, the intervals could be made 5 times as wide as what is seen in the simulations to account for other parameters having a more extreme solution. Similarly, the output of the neural network may be treated as a residual against some linear system, say A*NN, where NN is the output of the neural network and A is a pre-chosen matrix, or A*u+NN (u), to impose an average lincarization (i.e., an average Jacobian value) of the solution directly into the training architecture.

During the training process, when certain parameters are deemed important, simulations can be run in those areas to determine if the previously made assumptions are correct as these new parameters to potentially update the assumptions which are baked into the architecture.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that cach block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, cach block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that cach block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, clements, and/or components, but do not preclude the presence or addition of one or more other features, integers, steps, operations, clements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Machine learning (ML) is the use of computer algorithms that can improve automatically through experience and by the use of data. Machine learning algorithms build a model based on sample data, known as training data, to make predictions or decisions without being explicitly programmed to do so. Machine learning algorithms are used where it is unfeasible to develop conventional algorithms to perform the needed tasks.

In certain embodiments, instead of or in addition to performing the functions described herein manually, the system may perform some or all of the functions using machine learning or artificial intelligence. Thus, in certain embodiments, machine learning-enabled software relies on unsupervised and/or supervised learning processes to perform the functions described herein in place of a human user.

Machine learning may include identifying one or more data sources and extracting data from the identified data sources. Instead of or in addition to transforming the data into a rigid, structured format, in which certain metadata or other information associated with the data and/or the data sources may be lost, incorrect transformations may be made, or the like, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In certain embodiments, machine learning-based software assembles data into an organized format using one or more unsupervised learning techniques. Unsupervised learning techniques can identify relationship between data elements in an unstructured format.

In certain embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyper parameters of a decision tree based on the training data set. In other embodiments, machine learning-based software may use Bayesian algorithms or clustering algorithms to generate predicting models. In yet other embodiments, machine learning-based software may use association rule mining, artificial neural networks, and/or deep learning algorithms to develop models. In some embodiments, to improve the efficiency of the model generation, machine learning-based software may utilize hardware optimized for machine learning functions, such as an FPGA.

The system disclosed herein may be implemented as a client/server type architecture but may also be implemented using other architectures, such as cloud computing, software as a service model (SaaS), a mainframe/terminal model, a stand-alone computer model, a plurality of non-transitory lines of code on a computer readable medium that can be loaded onto a computer system, a plurality of non-transitory lines of code downloadable to a computer, and the like.

The system may be implemented as one or more computing devices that connect to, communicate with and/or exchange data over a link that interact with each other. Each computing device may be a processing unit-based device with sufficient processing power, memory/storage and connectivity/communications capabilities to connect to and interact with the system. For example, each computing device may be an Apple iPhone or iPad product, a Blackberry or Nokia product, a mobile product that executes the Android operating system, a personal computer, a tablet computer, a laptop computer and the like and the system is not limited to operate with any particular computing device. The link may be any wired or wireless communications link that allows the one or more computing devices and the system to communicate with each other. In one example, the link may be a combination of wireless digital data networks that connect to the computing devices and the Internet. The system may be implemented as one or more server computers (all located at one geographic location or in disparate locations) that execute a plurality of lines of non-transitory computer code to implement the functions and operations of the system as described herein. Alternatively, the system may be implemented as a hardware unit in which the functions and operations of the back-end system are programmed into a hardware system. In one implementation, the one or more server computers may use Intel® processors, run the Linux operating system, and execute Java, Ruby, Regular Expression, Flex 4.0, SQL etc.

In some embodiments, each computing device may further comprise a display and a browser application so that the display can display information generated by the system. The browser application may be a plurality of non-transitory lines of computer code executed by a processing unit of the computing device. Each computing device may also have the usual components of a computing device such as one or more processing units, memory, permanent storage, wireless/wired communication circuitry, an operating system, etc.

The system may further comprise a server (that may be software based or hardware based) that allows each computing device to connect to and interact with the system such as sending information and receiving information from the computing devices that is executed by one or more processing units. The system may further comprise software- or hardware-based modules and database(s) for processing and storing content associated with the system, metadata generated by the system for each piece of content, user preferences, and the like.

In one embodiment, the system includes one or more processors, server, clients, data storage devices, and non-transitory computer readable instructions that, when executed by a processor, cause a device to perform one or more functions. It is appreciated that the functions described herein may be performed by a single device or may be distributed across multiple devices.

When a user interacts with the system, the user may use a frontend client application. The client application may include a graphical user interface that allows the user to select one or more digital files. The client application may communicate with a backend cloud component using an application programming interface (API) comprising a set of definitions and protocols for building and integrating application software. As used herein, an API is a connection between computers or between computer programs that is a type of software interface, offering a service to other pieces of software. A document or standard that describes how to build or use such a connection or interface is called an API specification. A computer system that meets this standard is said to implement or expose an API. The term API may refer either to the specification or to the implementation.

Software-as-a-service (SaaS) is a software licensing and delivery model in which software is licensed on a subscription basis and is centrally hosted. SaaS is typically accessed by users using a thin client, e.g., via a web browser. SaaS is considered part of the nomenclature of cloud computing.

Many SaaS solutions are based on a multitenant architecture. With this model, a single version of the application, with a single configuration (hardware, network, operating system), is used for all customers (“tenants”). To support scalability, the application is installed on multiple machines (called horizontal scaling). The term “software multitenancy” refers to a software architecture in which a single instance of software runs on a server and serves multiple tenants. Systems designed in such manner are often called shared (in contrast to dedicated or isolated). A tenant is a group of users who share a common access with specific privileges to the software instance. With a multitenant architecture, a software application is designed to provide every tenant a dedicated share of the instance—including its data, configuration, user management, tenant individual functionality and non-functional properties.

The backend cloud component described herein may also be referred to as a SaaS component. One or more tenants which may communicate with the SaaS component via a communications network, such as the Internet. The SaaS component may be logically divided into one or more layers, each layer providing separate functionality and being capable of communicating with one or more other layers.

Cloud storage may store or manage information using a public or private cloud. Cloud storage is a model of computer data storage in which the digital data is stored in logical pools. The physical storage spans multiple servers (sometimes in multiple locations), and the physical environment is typically owned and managed by a hosting company. Cloud storage providers are responsible for keeping the data available and accessible, and the physical environment protected and running People and/or organizations buy or lease storage capacity from the providers to store user, organization, or application data. Cloud storage services may be accessed through a co-located cloud computing service, a web service API, or by applications that utilize the API.

What is claimed is:

1. A computer system for improving automated surrogate training performance by incorporating simulator information, the computer system comprising:
a memory, and
a processor, the processor configured for:
performing a simulation of a system being modeled;
identifying, based on the simulation of the system being modeled, information about the system being modeled;
modifying an architecture of a surrogate of the system being modeled, wherein the architecture of the surrogate is modified to incorporate the identified information about the system being modeled; and
training the surrogate with the information about the system being modeled to generate a final surrogate.

2. The computer system of claim 1, wherein the processor is further configured for updating the identified information about the system being modeled during a training process for the surrogate as more information is learned through a sampling process.

3. The computer system of claim 1, wherein the identified information about the system being modeled includes average Jacobian norms, Jacobian eigenvalues, a maximum value of at least one state over time, or a minimum value of at least one state over time.

4. The computer system of claim 1, wherein the surrogate includes a reservoir that is constructed by exciting a fixed neural network layer with a chosen input, wherein a response of the fixed neural network evolves over time.

5. The computer system of claim 4, wherein dynamics of the reservoir of the surrogate are scaled by a factor that represents a time scale associated with dynamics of the system being modeled such that the surrogate uses the time scale associated with dynamics of the system being modeled, or the dynamics of the reservoir of the surrogate are adjusted to introduce periodicity in the surrogate.

6. The computer system of claim 1, wherein the surrogate is a continuous-time echo-state network, a neural network, or a physics-informed neural network.

7. The computer system of claim 6, wherein when the surrogate is a physics-informed neural network, the physics-informed neural network is constrained by using a sigmoid activation function.

8. The computer system of claim 7, wherein the constrained physics-informed neural network is scaled by a scale factor of s.

9. A method for improving automated surrogate training performance by incorporating simulator information, the method comprising:
performing a simulation of a system being modeled;
identifying, based on the simulation of the system being modeled, information about the system being modeled;
modifying an architecture of a surrogate of the system being modeled, wherein the architecture of the surrogate is modified to incorporate the identified information about the system being modeled; and
training the surrogate with the information about the system being modeled to generate a final surrogate.

10. The method of claim 9, further comprising updating the identified information about the system being modeled during a training process for the surrogate as more information is learned through a sampling process.

11. The method of claim 9, wherein the identified information about the system being modeled includes average Jacobian norms, Jacobian eigenvalues, a maximum value of at least one state over time, or a minimum value of at least one state over time.

12. The method of claim 9, wherein the surrogate includes a reservoir that is constructed by exciting a fixed neural network layer with a chosen input, with a response of the fixed neural network evolves over time.

13. The method of claim 12, wherein dynamics of the reservoir of the surrogate are scaled by a factor that represents a time scale associated with dynamics of the system being modeled such that the surrogate uses the time scale associated with dynamics of the system being modeled, or the dynamics of the reservoir of the surrogate are adjusted to introduce periodicity in the surrogate.

14. The method of claim 9, wherein the surrogate is a continuous-time echo-state network, a neural network, or a physics-informed neural network.

15. The method of claim 14, wherein when the surrogate is a physics-informed neural network, the physics-informed neural network is constrained by using a sigmoid activation function.

16. A system for improving automated surrogate training performance by incorporating simulator information, the computer system comprising:
a memory, and
a processor, the processor configured for:
creating a model of a system being modeled;
defining a surrogate having a surrogate architecture for the model of the system being modeled, wherein the surrogate architecture is a CTESN, a neural network, a PINN, or a neural ODE;
performing one or more simulations of the model to identify information about the system being modeled;
identifying, based on the one or more simulations of the model, information about the system being modeled, wherein the identified information about the system includes average Jacobian norms, Jacobian eigenvalues, maximum or minimum values of states of the model over time, mean values of states of the model over time, length of time to run the simulation, maximum of a time series of the model, natural bounds of the model, or periodicity of the model;
generating an improved surrogate by modifying the surrogate architecture using the identified information about the system being modeled from the one or more simulations; and
generating a final surrogate by training the improved surrogate.

17. The system of claim 16, wherein the processor is further configured for updating the identified information about the system being modeled during a training process for the improved surrogate as additional information is learned about the system being modeled through a sampling process.

18. The system of claim 16, wherein the surrogate architecture includes a reservoir constructed by exciting a fixed neural network layer with a chosen input, wherein a response of the fixed neural network evolves over time.

19. The system of claim 18, wherein dynamics of the reservoir of the surrogate architecture are scaled by a factor that represents a time scale associated with dynamics of the system being modeled such that the surrogate uses the time scale associated with dynamics of the system being modeled.

20. The system of claim 18, wherein the dynamics of the reservoir of the surrogate architecture are modified to introduce periodicity in the surrogate.
